(19) United States
(12) Patent Application Publication
(10) Pub. No.: US 2026/0093342 A1
(43) Pub. Date: Apr. 2, 2026

(54) KEYBOARD WITH BUFFER AND SILENT FUNCTIONS

(71) Applicant: Voyetra Turtle Beach, Inc., White Plains, NY (US)

(72) Inventors: Yu Hsun CHEN, New Taipei City (TW); Ying Chieh HUNG, New Taipei City (TW); Chih Wei HUNG, New Taipei City (TW); Thaddaeus Erasmus Georg Richard TETZNER, Hamburg (DE)

(73) Assignee: Voyetra Turtle Beach, Inc., White Plains, NY (US)

(21) Appl. No.: 19/114,931

(22) PCT Filed: Sep. 25, 2023
(86) PCT No.: PCT/US2023/075007

§ 371 Date: Mar. 25, 2025

(30) Foreign Application Priority Data
Sep. 27, 2022 (TW) 111136603
Sep. 27, 2022 (TW) 111210528
Oct. 8, 2022 (CN) 202211220856.0
Oct. 8, 2022 (CN) 202222627887.X

(51) Int. Cl. G06F 3/02

(52) U.S. Cl. CPC G06F 3/0202

(57) ABSTRACT

A keyboard with buffer and silent functions includes: a housing, a key group, a switch group, a positioning board, a first buffer board, and a circuit board. The key group may include a plurality of key caps arranged on the switch bodies. The switch group may include a plurality of switch bodies installed inside the housing and exposed from a surface thereof. The positioning board may be located on one side of the switch group in an opposite direction to the key group. The first buffer board may be arranged on one side of the positioning board in an opposite direction to the switch group. The circuit board may be located on one side of the first buffer board in an opposite direction to the positioning board. An elastic element may be provided between the positioning board and the circuit board in contact with the housing.

### CROSS-REFERENCE TO RELATED APPLICATIONS

This application claims the benefit of Taiwan Invention Application No. 111136603, filed Sep. 27, 2022, Taiwan Utility Model Application No. 111210528, filed Sep. 27, 2022, Chinese Invention Application No. 202211220856.0, filed Oct. 8, 2022, and Chinese Utility Model Application No. 202222627887.X, filed Oct. 8, 2022.

### TECHNICAL FIELD

The present application relates to a keyboard, in particular to a keyboard with buffer and silent functions, which not only has the effects of buffer and sound absorption, but also has the effects of good touch and shock absorption.

### BACKGROUND ART

A keyboard is a device in the form of a typewriter, and is composed of a combination of keys and electronic switching systems of different keyboard technologies. Its main function is to input data; in addition, it may be used in a computer system to operate other machines or devices.

In order to achieve a silent effect, today's keyboards are provided with at least one buffer board below a fixing board inside the keyboard housing. Thus, the buffer board is used to absorb the sound generated by key typing or the impact sound generated between an electronic part and the housing. However, this type of sound-absorbing effect is quite limited.

In view of the foregoing, some floating blocks may be installed around the fixing board. However, in such a design, the floating blocks need to be installed on the fixing board one by one; this can cause trouble in the production and installation of the keyboard. In addition, since a plurality of floating blocks needs to be installed around the fixing board, if the installation is not perfect, or if some floating blocks fall off, it may cause difficulties during installation of components to be stacked on the fixing board. In addition, it may also affect the sound absorption and buffer effects.

### SUMMARY

Therefore, according to various aspects, an elastic element is provided between the positioning board and the circuit board within the keyboard, where the elastic element is in contact with the housing to provide the effects of buffer and sound absorption, so that the assembly thereof can move up and down in the keyboard to achieve the effects of good touch and shock absorption.

Some implementations provide a keyboard with buffer and silent functions, which at least comprises: a housing; a key group, comprising a plurality of key caps; a switch group, comprising a plurality of switch bodies, wherein the plurality of switch bodies are installed inside the housing and exposed from a surface of the housing, and the plurality of key caps are arranged on the plurality of switch bodies; a positioning board, located on one side of the switch group, and arranged in an opposite direction to the key group, wherein the positioning board comprises a plurality of through holes thereon, and each switch body is positioned and installed in a corresponding through hole; a first buffer board, located on one side of the positioning board, and arranged in an opposite direction to the switch group, wherein the first buffer board comprises a plurality of penetrating holes corresponding to the plurality of through holes to allow the plurality of switch bodies to pass therethrough; a circuit board, located on one side of the first buffer board, and arranged in an opposite direction to the positioning board; an elastic element is provided between the positioning board and the circuit board, and the elastic element is in contact with the housing.

In one embodiment of the present application, the elastic element is arranged between the positioning board and the circuit board, and is ringed around the first buffer board.

In one embodiment of the present application, the elastic element is an annular body.

In one embodiment of the present application, the elastic element is made of rubber, sponge, or foam.

In one embodiment of the present application, an area of the first buffer board is smaller than an area of the positioning board.

In one embodiment of the present application, a top surface of each of the plurality of key caps has a pattern layer of a character, a number, or a symbol.

In one embodiment of the present application, the housing comprises an upper cover, a lower cover, and an engaging board, a surface of the upper cover has a plurality of holes in different rectangular shapes, and the plurality of holes allow the key group and the switch group to be exposed therefrom.

In one embodiment of the present application, the lower cover has a honeycomb structure therein.

In one embodiment of the present application, one side of the engaging board has an engaging slot, one side of the upper cover and one side of the lower cover each has a slide rail, and in the case where the upper cover and the lower cover are engaged, the engaging slot of the engaging board is engaged with the slide rail on the upper cover and the slide rail on the lower cover, so that the upper cover and the lower cover are assembled together.

In one embodiment of the present application, the keyboard further comprises a second buffer board, wherein the second buffer board is installed inside the housing, located on one side of the circuit board, and is arranged in an opposite direction to the first buffer board.

In one embodiment of the present application, the keyboard further comprises a third buffer board, wherein the third buffer board is located on one side of the second buffer board, and arranged in an opposite direction to the circuit board.

### BRIEF DESCRIPTION OF THE DRAWINGS

FIG. 1 is a schematic perspective exploded view of a keyboard according to one embodiment;

FIG. 2 is a schematic bottom view of a combination of a positioning board, a first buffer board and an elastic element within a keyboard according to one embodiment;

FIG. 3 is a schematic top view of FIG. 2;

FIG. 4 is a schematic cross-sectional view of a keyboard combination according to the present one embodiment.

Description of the element symbols shown in the drawings:
10 keyboard;
1 housing;
11 upper cover;
111 hole;
112 slide rail;
12 lower cover;
122 slide rail;
121 honeycomb structure;
13 engaging board;
131 engaging slot;
2 key group;
21 key cap;
3 switch group;
31 switch body;
4 positioning board;
41 through hole;
5 first buffer board;
51 penetrating hole;
6 elastic element;
7 circuit board;
8 second buffer board;
9 third buffer board.

### DESCRIPTION OF THE EMBODIMENTS

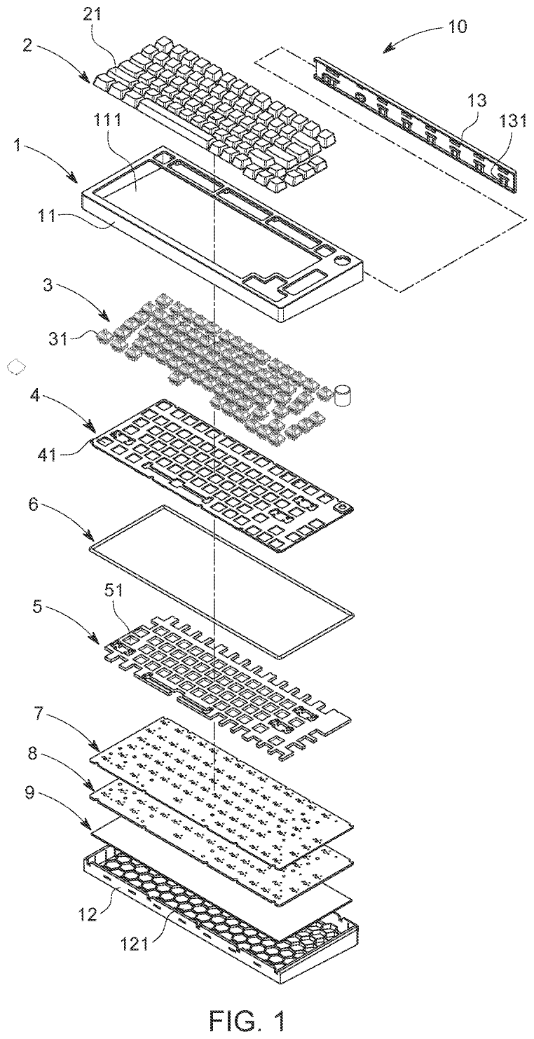

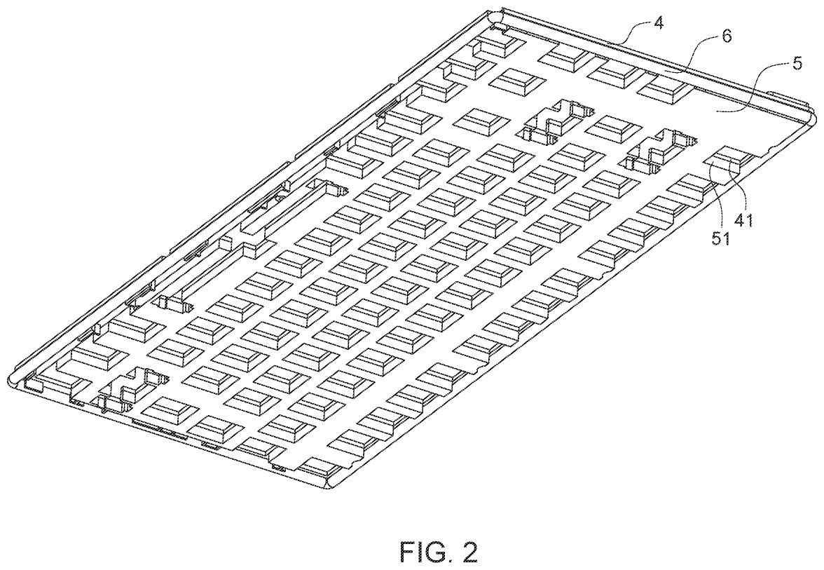

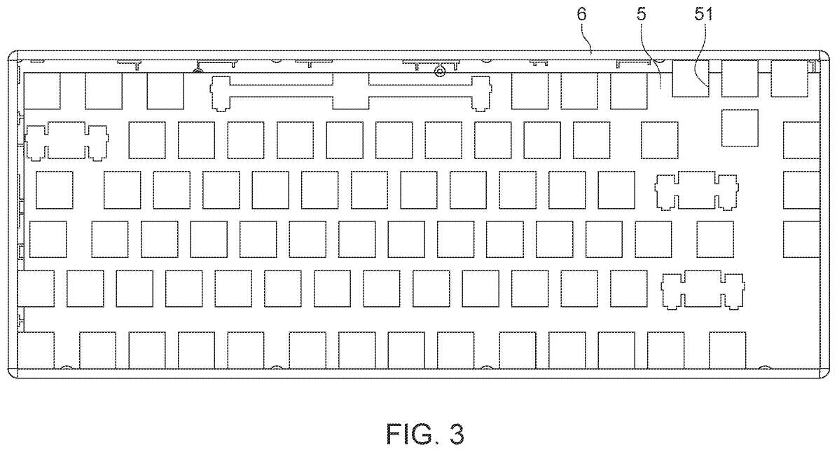

The detailed description and technical contents of the present application will be provided below in conjunction with the accompanying drawings. Please refer to FIG. 1 to 3, which are respectively a schematic perspective exploded view of a keyboard, a schematic bottom view of a combination of a positioning board, a first buffer board and an elastic element within a keyboard, and a schematic top view of FIG. 2. As shown in the figures, a keyboard with buffer and silent functions is provided in the present application. The keyboard 10 includes: a housing 1, a key group 2, a switch group 3, a positioning board 4, a first buffer board 5, an elastic element 6, a circuit board 7, a second buffer board 8, and a third buffer board 9. The elastic element 6 is installed between the positioning board 4 and the circuit board 7, and only the elastic element 6 is in contact with both the upper cover 11 and the lower cover 12 of the housing 1. Due to the elastic property of the elastic element 6, when the keyboard 10 is pressed, an assembly formed by the upper cover 11, the key group 2, the switch group 3, the positioning board 4, the first buffer board 5, the elastic element 6, the circuit board 7 and the second buffer board 8 can move up and down within the keyboard 10, so as to achieve the effects of good touch and shock absorption.

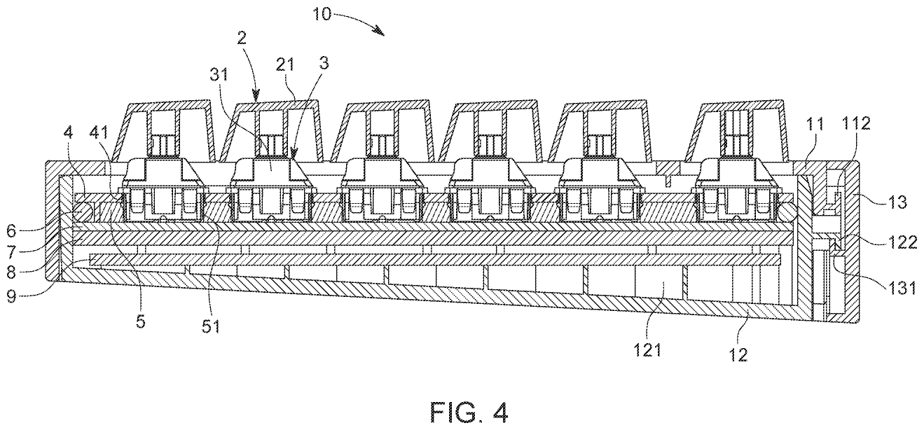

The housing 1 includes an upper cover 11, a lower cover 12 and an engaging board 13. The surface of the upper cover 11 has a plurality of holes 111 in different rectangular shapes, and the plurality of holes 111 allow the key group 2 and the switch group 3 to be exposed therefrom. The lower cover 12 has a honeycomb structure 121 in it. The honeycomb structure 121 is a closely packed hexagonal structure like a honeycomb, which has the characteristics of saving material and improving strength. In addition, there is an engaging slot 131 on one side of the engaging board 13, and slide rails 112, 122 on one side of the upper cover 11 and one side of the lower cover 12 respectively. After the upper cover 11 and the lower cover 12 are combined to each other, the engaging slot 131 of the engaging board 13 is engaged with the slide rails 112, 122 (as shown in FIG. 4), such that the upper cover 11 and the lower cover 12 can be assembled together.

The key group 2 is composed of a plurality of key caps 21 and arranged on the switch group 3. In addition, the top surface of each of the plurality of key caps 21 has a pattern layer of a character, a number, or a symbol (not shown in the figures), so as to indicate the specific position of each key for users.

The switch group 3 is composed of a plurality of switch bodies 31. The plurality of switch bodies 31 are disposed on the positioning board 4 and exposed from the plurality of holes 111 provided on the upper cover 11. After the plurality of switch bodies 31 are pressed, the contact points (not shown in the figures) of the plurality of switch bodies 31 can contact the conduction points (not shown in the figures) of the circuit board 7 so as to generate the output of an operation instruction signal(s).

The positioning board 4 is located on one side of the switch group 3, and is arranged in an opposite direction to the key group 2. It has a plurality of through holes 41 thereon, and each switch body 31 is positioned in a corresponding through hole 41. When each of the switch bodies 31 is pressed, the contact points (not shown in the figures) of the plurality of switch bodies 31 can be contacted via the conduction points (not shown in the figures) on the circuit board 7 so as to generate the output of an operation instruction signal(s).

The first buffer board 5 is disposed on one side of the positioning board 4 and arranged in an opposite direction to the switch group 3. The first buffer board 5 has a plurality of penetrating holes 51 corresponding to the through holes 41; the plurality of penetrating holes 51 are used for the switch bodies 31 to pass therethrough. When each of the switch bodies 31 is pressed, the contact points (not shown in the figures) of the plurality of switch bodies 31 can be in contact with the conduction points on the circuit board 7 so as to generate the output of an operation instruction signal(s). At the same time, the first buffer board 5 can absorb the sound generated when the switch bodies 31 are pressed. As shown in the drawings, the area of the first buffer board 5 is smaller than the area of the positioning board 4.

The elastic element 6 is disposed on one side of the positioning board 4. The elastic element 6 can be an annular body, and can be arranged around the first buffer board 5. As shown in the drawings, the elastic element 6 may be made of rubber, sponge or foam.

The circuit board 7 is located on one side of the first buffer board 5 and arranged in an opposite direction to the positioning board 4. The circuit board 7 can generate an operation instruction signal and output the signal to an external electronic device (such as a computer) when each switch body 31 is pressed.

The second buffer board 8 is located on one side of the circuit board 7 and arranged in an opposite direction to the first buffer board 5. The second buffer board 8 can absorb the force and sound generated when the key group 2 and the switch group 3 are pressed.

The third buffer board 9 is located on one side of the second buffer board 8 and arranged in an opposite direction to the circuit board 7. The third buffer board 9 can prevent the circuit board 7 and certain electronic parts (not shown in the figures) from colliding with the lower cover 12, and assist the entire keyboard in buffering and reducing noise.

Please refer to FIG. 4, which is a schematic cross-sectional view of a keyboard combination according to the present application, and further refer to FIG. 1 to 3. As shown in the figures, when the keyboard is assembled, each switch body 31 in the switch group 3 can be installed on the positioning board 4, and the elastic element 6 can be installed around the first buffer board 5. As viewed from one side of the positioning board 4, the first buffer board 5, the circuit board 7, the second buffer board 8 and the third buffer board 9 are stacked together from top to bottom.

The switch group 3, the positioning board 4, the first buffer board 5, the elastic element 6, the circuit board 7, the second buffer board 8 and the third buffer board 9 can be stacked together and installed in the housing 1 between the upper cover 11 and the lower cover 12. Thus, each switch body 31 of the switch group 3 can pass through the holes 111 on the upper cover 11, and then each key cap 21 of the key group 2 can be installed on the switch bodies 31. Subsequently, the engaging slot 131 on the engaging board 13 can be engaged with the sliding rails 112, 122; thus the upper cover 11 and the lower cover 12 can be engaged together.

After the keyboard 10 is assembled as mentioned above, the elastic element 6 is installed between the positioning board 4 and the circuit board 7, and is arranged around the first buffer board 5. In such a case, only the elastic element 6 is in contact with the upper cover 11 and the lower cover 12 of the housing 1. Due to the elastic properties of the elastic element 6, when the keyboard 10 is pressed, the upper cover 11, the key group 2, the switch group 3, the positioning board 4, the first buffer board 5, the elastic element 6, the circuit board 7 and the second buffer board 8 can form a combined assembly to move up and down within the keyboard 10. Thus, the keyboard 10 can achieve the effects of good touch and shock absorption when in use.

The above is only some preferred embodiments of the present application, which do not limit the scope of protection of the present application. It is noted that all equivalent structural changes made based on the contents of the description and drawings of the present application are all included within the scope of protection of the present application. While various embodiments of the disclosed technology are described above, it should be understood that they have been presented by way of example only, and not of limitation. Likewise, the various diagrams may depict an example configuration for the disclosed technology, which is done to aid in understanding the features and functionality that can be included in the disclosed technology. The disclosed technology is not restricted to the illustrated examples, and the desired features can be implemented using a variety of alternative configurations. Indeed, it will be apparent to one of skill in the art after reading the above description how alternative functional, logical or physical configurations can be implemented to achieve the desired features of the technology disclosed herein.

What is claimed is:

1. A keyboard, comprising:
a housing;
a key group, comprising a plurality of key caps;
a switch group, comprising a plurality of switch bodies, wherein the plurality of switch bodies are located inside the housing and exposed at a surface of the housing, and the plurality of key caps are arranged on the plurality of switch bodies;
a positioning board, located on one side of the switch group, and arranged in an opposite direction to the key group, wherein the positioning board comprises a plurality of through holes thereon, and each switch body is positioned and installed in a corresponding through hole;
a first buffer board, located on one side of the positioning board, and arranged in an opposite direction to the switch group, wherein the first buffer board comprises a plurality of penetrating holes corresponding to the plurality of through holes to allow the plurality of switch bodies to pass therethrough; and
a circuit board, located on one side of the first buffer board, and arranged in an opposite direction to the positioning board;
wherein an elastic element is provided between the positioning board and the circuit board, and the elastic element is in contact with the housing.

2. The keyboard according to claim 1, wherein the elastic element is arranged between the positioning board and the circuit board, and is ringed around the first buffer board.

3. The keyboard according to claim 1, wherein an area of the first buffer board is smaller than an area of the positioning board.

4. The keyboard according to claim 1, wherein the elastic element is an annular body.

5. The keyboard according to claim 1, wherein the elastic element is made of rubber, sponge, or foam.

6. The keyboard according to claim 1, wherein a top surface of each of the plurality of key caps comprises a pattern layer of a character, a number, or a symbol.

7. The keyboard according to claim 1, wherein the housing comprises an upper cover, a lower cover, and an engaging board, a surface of the upper cover comprises a plurality of holes in different rectangular shapes, and the plurality of holes allow the key group and the switch group to be exposed therefrom.

8. The keyboard according to claim 7, wherein the lower cover comprises a honeycomb structure therein.

9. The keyboard according to claim 8, wherein one side of the engaging board comprises an engaging slot, one side of the upper cover and one side of the lower cover each comprise a slide rail, and in upon engagement of the upper cover with the lower cover, the engaging slot of the engaging board is engaged with the slide rail on the upper cover and the slide rail on the lower cover.

10. The keyboard according to claim 1, further comprising a second buffer board, wherein the second buffer board is installed inside the housing, located on one side of the circuit board, and is arranged in an opposite direction to the first buffer board.

11. The keyboard according to claim 10, further comprising a third buffer board, wherein the third buffer board is located on one side of the second buffer board, and arranged in an opposite direction to the circuit board.
